(19) United States
(12) Patent Application Publication
(10) Pub. No.: US 2017/0014783 A1
(43) Pub. Date: Jan. 19, 2017

(54) AERATOR AND CONTAINER-AERATOR ASSEMBLY

(71) Applicant: Guala Closures S.p.A., Alessandria (IT)

(72) Inventors: Luca Viale, Alessandria (IT); Marco Giovannini, Luxembourg (LU); Carlo Tagliabue, Monza (IT)

(21) Appl. No.: 15/211,489

(22) Filed: Jul. 15, 2016

(30) Foreign Application Priority Data
Jul. 16, 2015 (IT) 102015000034949

(51) Int. Cl. B01F 3/04; B65D 23/12; C12G 1/00; B65D 1/02; B01F 13/00; B01F 5/04

(52) U.S. Cl. CPC B01F 3/04794; B01F 13/002; B01F 5/0428; C12G 1/00; B65D 1/023; B65D 23/12; B01F 2003/04943; B01F 2003/04872; B01F 2215/0072

(57) ABSTRACT

An aerator comprises a tubular member, an air recovery conduit and aeration members. The aeration members comprise an aeration conduit that projects from the outer surface of the tubular member.

### CROSS-REFERENCE TO RELATED APPLICATION

This application claims the benefit of Italian Patent Application No. 102015000034949 filed Jul. 16, 2015, which is incorporated herein by reference.

### FIELD OF THE INVENTION

The present invention refers to an aerator for aerating a liquid, for example wine or liquor, when such liquid is poured from a container.

### BACKGROUND INFORMATION

Wine aerators are known in the state of the art and are used to aerate particularly, but not exclusively, wines that need oxygenation due to the long time spent in the bottle.

Examples of aerators are described in documents WO 2014/011523 and US 2012/0074092.

WO 2014/011523 describes an aerator mounted in the neck of a container and formed from a Venturi tube with a narrow portion provided with air passage holes to introduce air into the Venturi tube when the liquid is poured through the Venturi tube. In some embodiments holes are provided for the passage of air in the container during pouring, while in other embodiments a conduit is provided for the passage of air. The air passage holes for the Venturi tube are insufficient to effectively aerate the liquid being poured. Moreover, the technical solution with the holes for the passage of air in the container is unacceptable since it substantially limits the pouring flow rate.

US 2012/0074092 describes an aerator mounted in the neck of a container. The aerator comprises a central channel and many channels formed laterally in the body of the aerator to take air into the central channel and thus mix the liquid that is poured. Since the aerator is mounted in direct contact with the neck of the container, a lateral channel is also provided for the passage of air in the container during pouring. In this solution, the lateral channels for feeding air to the central channel do not allow sufficient air to be brought into the central channel itself. Moreover, the structure requires a substantial amount of material since the inside of the neck of the container is substantially occupied by the aerator with the exception of the central channel and the lateral channels, including the one for the passage of air to the container.

### SUMMARY OF THE INVENTION

The purpose of the present invention is to propose an aerator that has effective aeration with a simple and cost-effective structure.

This and other purposes that will become clearer from the rest of the description are achieved with an aerator in accordance with claim 1.

### BRIEF DESCRIPTION OF THE DRAWINGS

The invention will now be described more clearly with reference to a preferred embodiment thereof, given only for indicating and not limiting purposes, illustrated in the attached drawings, in which:

FIG. 1 shows a perspective view of an aerator in accordance with one embodiment of the present invention,

FIGS. 2 and 3 show section views of the aerator of FIG. 1,

FIG. 4 shows a side view of the aerator of FIG. 1,

FIG. 5 shows another section view of the aerator of FIG. 1,

FIG. 6 shows a section view of an assembly of the neck of a container with the aerator of FIG. 1,

FIGS. 7 to 13 show different views of alternative embodiments of the aerator of the present invention.

### DETAILED DESCRIPTION

Even if not explicitly highlighted, the individual characteristics described with reference to the specific embodiments should be considered to be accessory and/or interchangeable with other characteristics, described with reference to other embodiments.

With reference to the figures, reference numeral 10 globally indicates an aerator in accordance with one embodiment of the present invention whereas reference numeral 1 indicates an assembly of the aerator 10 with a liquid container 100.

The liquid container 100 comprises a neck 101 having axis X that extends in a longitudinal direction X-X. The neck 101 has a mouth 102 and terminates at an annular edge 102a that delimits the mouth 102.

The neck 101 has inner surface 101a and outer surface 101b. In the example shown in the figures, the outer surface 101b is provided with a thread 103 configured to couple with a thread of a closure intended to close the container 100. However, the present invention also applied to flip-top closures, therefore ones without thread.

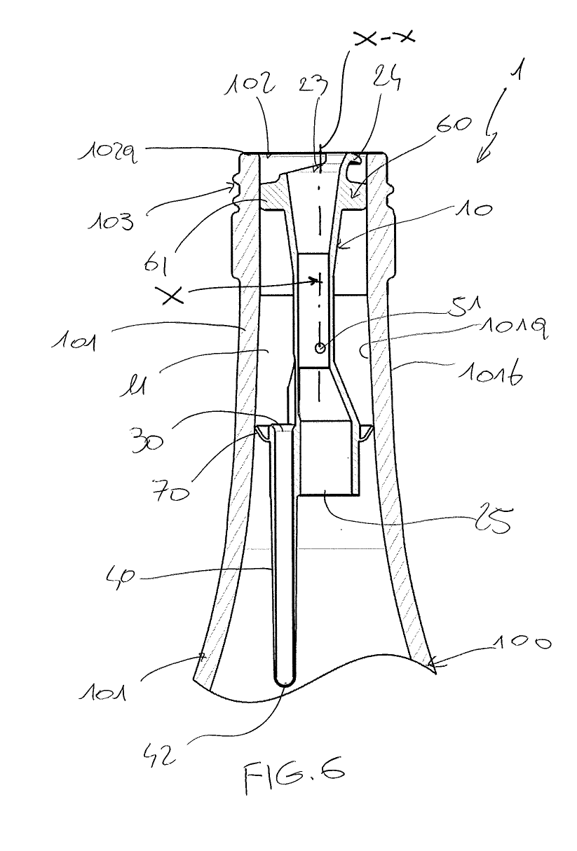

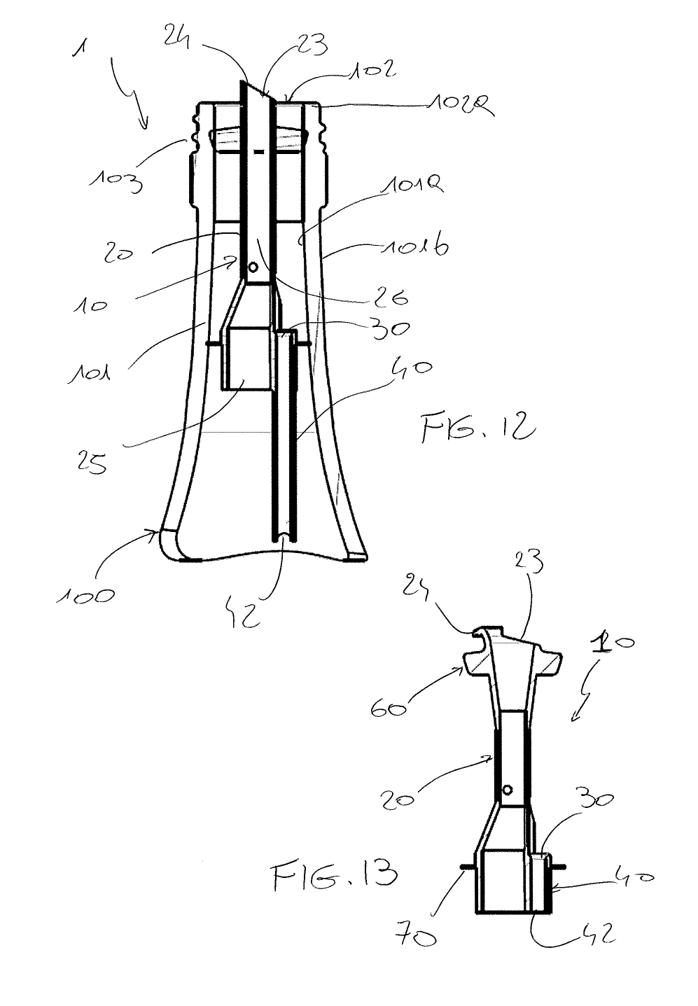

The aerator 10 is mounted at least partially inside the neck 101. In the example of FIG. 6, the aerator 10 is mounted completely inside the neck 101 whereas in the example of FIG. 12, a part of the aerator 10 longitudinally goes past the annular edge 102a.

The aerator 10 comprises a tubular member 20 that extends in the longitudinal direction X-X between a first end portion 21 and a second end portion 22.

The tubular member 20 has an outer surface 20a facing the inner surface 101a of the neck 101 along at least a longitudinal section and an inner surface 20b spaced from this inner surface 101a so as to define a gap 11 between the outer surface 20a of the tubular member 20 and the inner surface 101a of the neck 101 of the container 100.

The first end portion 21 defines a pouring orifice 23.

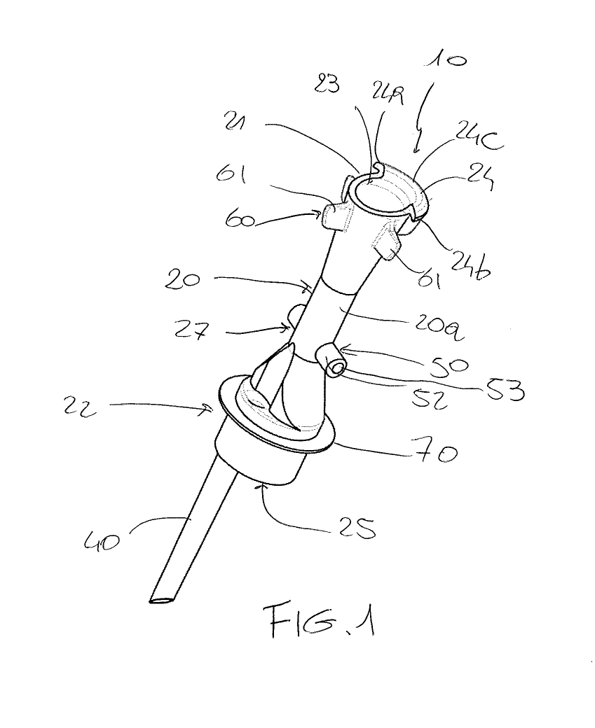

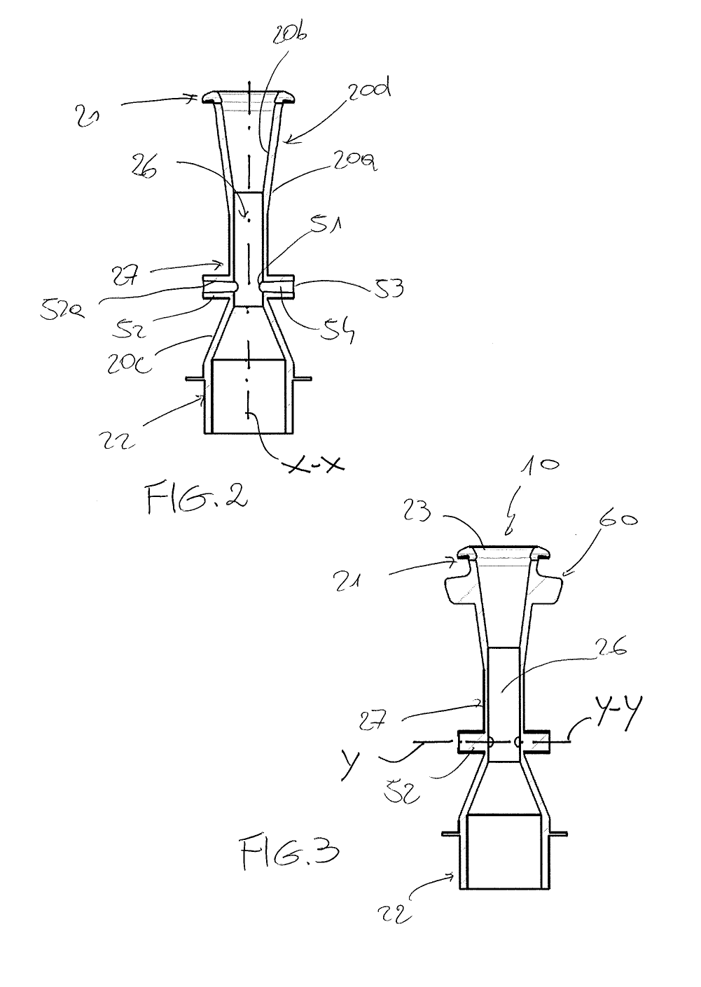

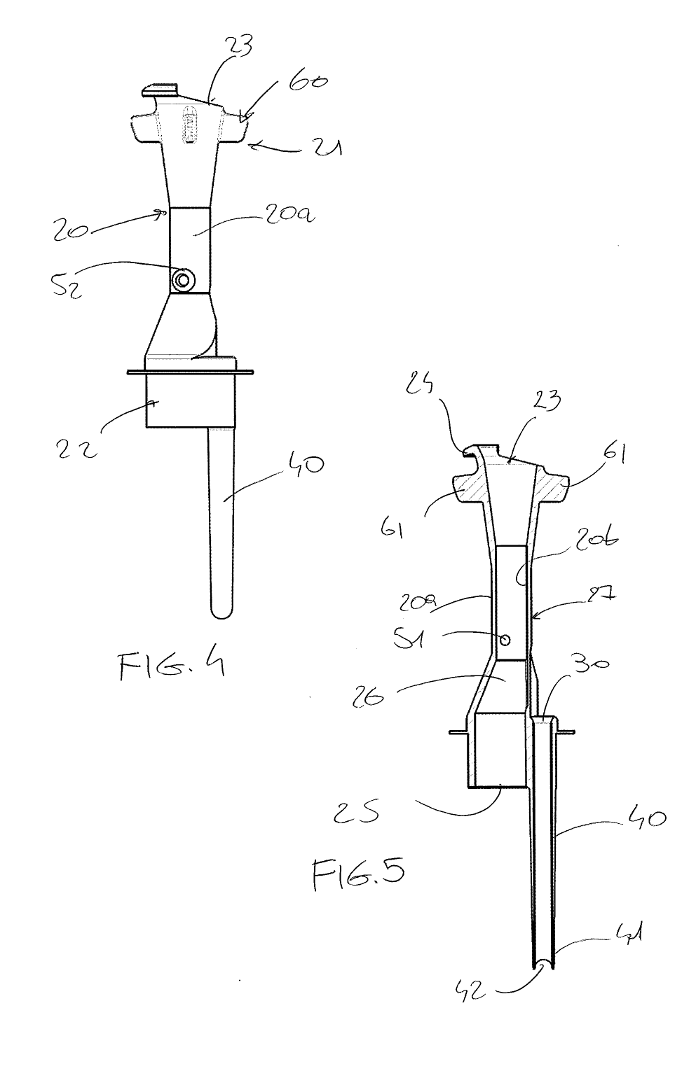

In accordance with the embodiments shown in FIGS. 1-9 and 13, the pouring orifice 23 is provided with a drip catching lip 24 projecting radially from the tubular member 20 transverse to the longitudinal direction X-X. The drip catching lip 24 extends angularly between two ends 24a,24b along a circumferential portion of the pouring orifice 23, preferably between 120° and 180°, and has a middle portion 24c between these two ends 24a,24b.

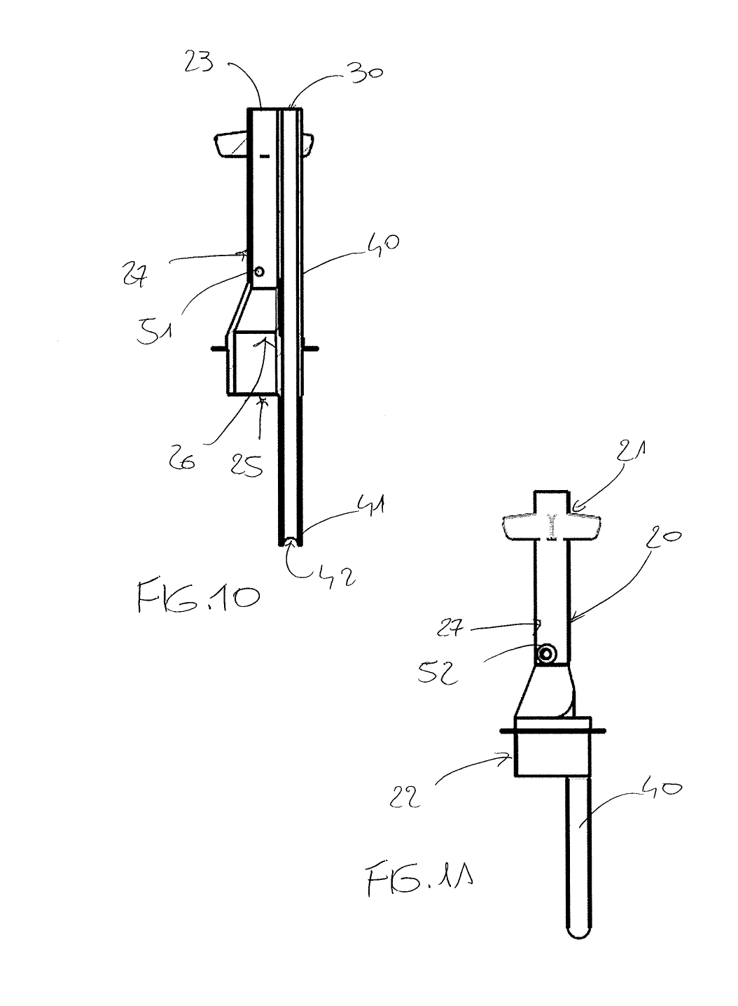

In the example of FIGS. 10 and 11, the pouring orifice 23 does not have a drip catching lip and has an annular shape.

In the example of FIG. 12, the pouring orifice 23 has a pouring edge 24 that projects only longitudinally and for a circumferential portion of the pouring orifice 23. In this example, the pouring edge 24 longitudinally goes past the annular edge 102a of the neck 101.

In the example of FIG. 6, on the other hand, the drip catching lip 24 is flush with the annular edge 102a of the neck 101.

The second end portion 22 of the tubular member 20 defines a liquid passage opening 25 for receiving the liquid to be poured coming from the container 100 and directed towards the pouring orifice 23 during use when the aerator 10 is mounted in the container 100.

The pouring orifice 23 has a section s1 whereas the liquid passage opening 25 has a section s2.

The tubular member 20 internally has a liquid passage channel 26 that extends between the liquid passage opening 25 and the pouring orifice 23 to establish fluid communication between the liquid passage opening 25 and the pouring orifice 23. The liquid passage channel 26 is delimited by the inner surface 20b. In particular, the tubular member 20 comprises a narrow portion 27 having section s3 smaller than the section s2 of the liquid passage opening 25 and, preferably, also smaller than the section s1 of the pouring orifice 23. The liquid coming from the container 100 and directed towards the pouring orifice 23 passes through the liquid passage opening 25 and before reaching the pouring orifice 23 it must cross the narrow portion 27 having section s3 smaller than that of the liquid passage opening 25. In this narrow portion 27, therefore, by Venturi effect, the speed of the liquid flowing towards the pouring orifice 23 increases and its pressure decreases.

In one embodiment, the ratio between the section s3 and the section s2 ranges from 0.1 to 0.4.

Preferably, the ratio between the section s3 and the section s1 ranges from 0.1 to 0.4.

Preferably, the tubular member 20 has a first tapered portion 20c with tapering from the liquid passage opening 25 to the narrow portion 27 to makes the section pass gradually from s2 to s3. Downstream of the narrow portion 27, in the longitudinal direction and in the flow direction of liquid coming out from the container 100 and directed towards the pouring orifice 23, the tubular member 20 has a second tapered portion 20d with tapering from the narrow portion 27 to the pouring orifice 23 to make the section pass gradually from s3 to s1.

The tapered portions 20c and 20d are preferably frusto-conical.

The aerator 10 also comprises an air recovery conduit 40 configured for introducing air into the container 100 when the contents of the container 100 are being poured through the pouring orifice 23.

In one embodiment, the tubular member 20 comprises an air recovery hole 30.

The air recovery conduit 40 is in fluid communication with the air recovery hole 30 and extends in the longitudinal direction X-X.

In the examples of FIGS. 1 to 9, 11 and 12, the air recovery hole 30 is formed at the second end portion 22 and the air recovery conduit 40 extends in the longitudinal direction X-X, on the opposite side to the tubular member 20, between the air recovery hole 30 and an air inlet portion 41 that defines an air inlet hole 42 for introducing air into the container 100 when the contents of the container 100 are being poured. The external air therefore passes in the gap 11, enters through the air recovery hole 30, passes in the air recovery conduit 40 and enters into the container 100 through the air inlet hole 42.

In the example of FIG. 10, the air recovery hole 30 is arranged at the pouring orifice 23 and the air recovery conduit 40 extends in the longitudinal direction X-X along the tubular member 20 and on the opposite sides to the tubular member 20 with respect to the second end portion 22, between the air recovery hole 30 and the air inlet hole 42. In this case, the external air enters through the air recovery hole 30 at the pouring orifice 23, passes in the air recovery conduit 40 and enters into the container 100 through the air inlet hole 42.

In the example of FIG. 13, the air recovery conduit 40 is configured like in FIGS. 1-9, 11 and 12 but it stops at the liquid passage opening 25.

Preferably, the tubular member 20 is provided with coupling members 60 arranged at the first end portion 21 and at least one coupling and sealing flange 70 arranged at the second end portion 22.

The coupling members 60 are interference-fitted inside the neck 101. Such coupling members 60, during the insertion of the aerator 10 in the neck 101, stop the aerator 10 in a predetermined longitudinal position with respect to the neck 101 and, in use, ensure that such a longitudinal position is maintained. They also allow the tubular member 20 to be kept spaced from the neck 101.

The coupling and sealing flange 70 engages in a sealed manner inside the neck 101. It identifies a further coupling portion between the aerator 10 and the neck 101 in longitudinally lower position than that of the coupling members 60. Therefore, together with the coupling members 60, it ensures stable positioning of the aerator 10 in the neck 101. Such a coupling and sealing flange 70 also has a sealing function and avoids liquid passing outside of the tubular member 20 from the second end portion 22 towards the first end portion 21 during pouring. Thanks to the coupling members 60 and the coupling and sealing flange 70, the tubular member 20 is stably mounted in the neck 101 and its outer surface 20a is spaced from the inner surface 101a of the neck 101.

In one embodiment, the coupling members 60 comprise a plurality of angular spaced wings 61, each wing 61 extending in the longitudinal direction X-X and projecting radially from the tubular member 20.

The aerator 10 also comprises at least one aeration member 50. Hereinafter, for the sake of simplicity of explanation, reference will be made in general to aeration members 50. The aeration members 50 are located at the narrow portion 27 and are in fluid communication with the liquid passage channel 26 to aerate the liquid flowing from the liquid passage opening 25 to the pouring orifice 23 through such a liquid passage channel 26 when it is being poured.

The aeration members 50 comprise one or more aeration holes 51 formed laterally in the tubular member 20 at the narrow portion 27 and one or more corresponding aeration conduits 52 in fluid communication with a respective aeration hole 51.

Each aeration conduit 52 projects from the aeration hole 51, outside of the tubular member 20, along an aeration direction Y-Y transverse to the longitudinal direction X-X.

Each aeration conduit 52 projects outside of the outer surface 20a of the tubular member 20 in the gap 11 to take the air present in such a gap 11 and introduce it into the liquid passage channel 26 at the narrow portion 27. In this narrow portion 27, there will thus be mixing of the external air with the liquid flowing in the liquid passage channel 26. The combination of the effects produced by the narrow portion 27 on the liquid flowing in the liquid passage channel 26 and by the aeration conduit 52 that introduces air with turbulence in this liquid amplify the aeration of the liquid and its oxygenation, with generation of bubbles in the flow of liquid.

In accordance with one embodiment, the aeration conduit 52 projects from the outer surface 20a, at the aeration hole 51, for at least 0.5 mm in the aeration direction Y-Y.

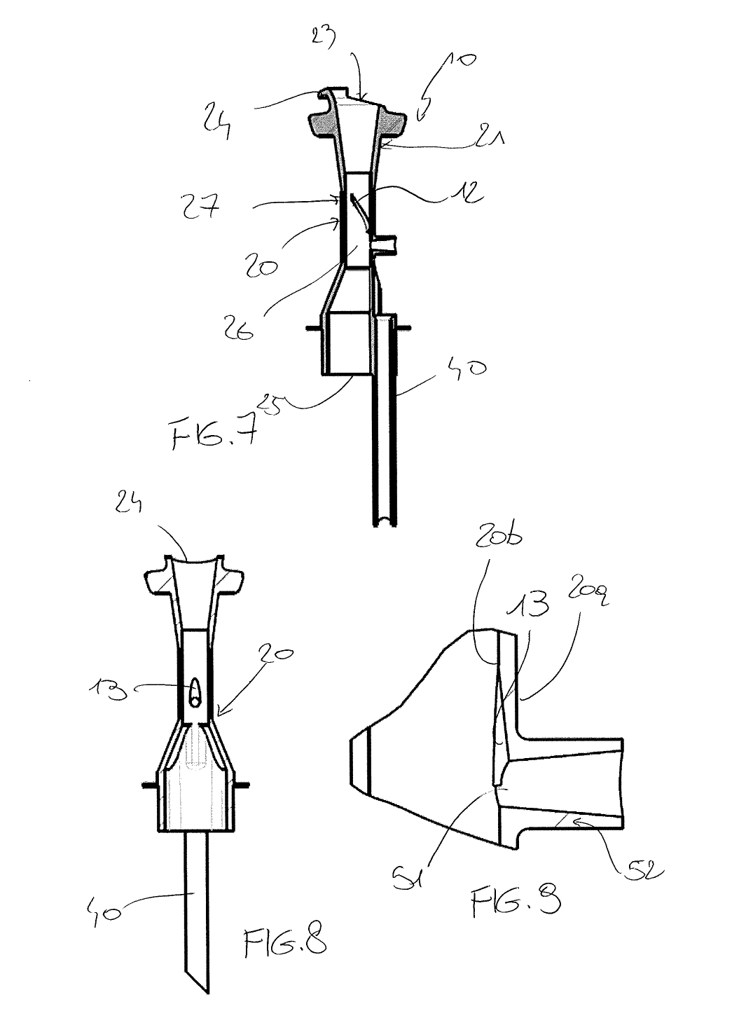

In order to generate turbulence of the air introduced by the aeration conduit 52 in the liquid passage channel 26 it is possible to provide a deviator element 12 projecting from the inner surface 20b of the tubular member 20 at the narrow portion 27 (FIG. 7) or to make a recess 13 in the inner surface 20b of the tubular member 20 at the narrow portion 27, in particular at the aeration hole 51 (FIGS. 8 and 9).

Preferably, the aeration direction Y-Y is perpendicular to the longitudinal direction X-X. The air entering into the aeration conduit 52 is thus forced to change direction both when entering into the aeration conduit 52 itself and when entering into the liquid passage channel 26 with consequent formation of turbulent motion that further improves the effectiveness of aeration.

The aeration conduit 52 extends between the aeration hole 51 and an aeration opening 53 and internally has an aeration channel 54 that establishes fluid communication between the aeration hole 51 and the aeration opening 53.

In a first embodiment, the aeration channel 54 has constant section from the aeration hole 51 to the aeration opening 53.

In a second embodiment, the aeration channel 54 is tapered with increasing section from the aeration hole 51 to the aeration opening 53. In this second embodiment, the Venturi effect in the aeration channel 54 and therefore the effectiveness of aeration increases.

In particular, the aeration channel 54 has an aeration axis Y extending along the aeration direction Y-Y. The aeration conduit 52 has an inner surface 52a that delimits the aeration channel 54 and tapers with respect to the aeration axis Y with an angle smaller than 25°, preferably ranging from 10° to 20°.

In one embodiment, the aeration members 50 comprise two aeration conduits 52, each in fluid communication with a respective aeration hole 51. The two aeration conduits 52 extend along respective aeration directions Y-Y and have parallel or coincident aeration axes.

Preferably, the tubular member 20 and the aeration member 50 are made in one piece.

More preferably, the tubular member 20, the air recovery conduit 40 and the aeration member 50 are made in one piece.

It has thus been seen how the aerator according to the present invention allows the purposes outlined above to be achieved.

Of course, those skilled in the art can bring numerous modifications and variants to the configurations described above, in order to satisfy contingent and specific requirements.

For example, it is clear that, except for clearly obvious technical impossibilities, any characteristic described in a preferred embodiment can be directly applied to another embodiment, with the appropriate adaptations. Equally, possible interruptions in the continuity of the elements making up the pourer can be made, clearly provided that they do not alter the functionality of the element in question. Similarly, the portions described as annular or cylindrical can have slight conicity due to technological requirements.

All of the modifications are in any case covered by the scope of protection of the invention as defined by the following claims.

1. An aerator configured to be mounted at least partially inside the neck of a liquid container having a neck and a mouth, said aerator comprising:
a tubular member extending in a longitudinal direction between a first end portion and a second end portion, said first end portion defining a pouring orifice and said second end portion defining a liquid passage opening for receiving the liquid to be poured that comes from the container and is directed toward said pouring orifice, said tubular member having internally a liquid passage channel which extends between said liquid passage opening and said pouring orifice to establish fluid communication between said liquid passage opening and said pouring orifice, said tubular member comprising a narrow portion whose section is smaller than the section of said liquid passage opening,
an air recovery conduit configured for introducing air into the container as the contents of the container are being poured,
at least one aeration member disposed at said narrow portion and in fluid communication with said liquid passage channel for aerating the liquid flowing from the liquid passage opening to the pouring orifice, as it is being poured, said at least one aeration member comprising at least one aeration hole formed in said tubular member at said narrow portion, wherein:
each aeration member comprises an aeration conduit in fluid communication with a respective aeration hole and projecting out of said respective aeration hole outside said tubular member in an aeration direction transverse to said longitudinal direction.

2. The aerator as claimed in claim 1, wherein:
said aeration direction is perpendicular to said longitudinal direction.

3. The aerator as claimed in claim 1, wherein:
said aeration conduit extends between said aeration hole and an aeration opening and has internally an aeration channel for establishing fluid communication between said aeration hole and said aeration opening.

4. The aerator as claimed in claim 3, wherein:
said aeration channel is tapered with an increasing section from said aeration hole to said aeration opening.

5. The aerator as claimed in claim 4, wherein:
said aeration channel has an aeration axis extending in said aeration direction,
said aeration conduit has an inner surface that delimits said aeration channel and tapers with respect to the aeration axis to form an angle of less than 25°, preferably ranging from 10° to 20°.

6. The aerator as claimed in claim 1, wherein:
said tubular member has coupling members at said first end portion,
said coupling members are configured for interference fit in the neck of a container.

7. The aerator as claimed in claim 6, wherein:
said coupling members comprise a plurality of angularly spaced wings,
each wing extends in said longitudinal direction and radially projects out of said tubular member.

8. The aerator as claimed in claim 1, wherein:
said tubular member comprises a coupling and sealing flange located outside said tubular member at said second end portion and configured for sealing engagement in the neck of a container.

9. The aerator as claimed in claim 1, wherein:
said at least one aeration member comprises two aeration conduits,
each aeration conduit is in fluid communication with and projects out of a respective aeration hole,
said two aeration conduits extend in respective parallel or coincident aeration directions.

10. The aerator as claimed in claim 1, wherein:
said pouring orifice has a drip catching lip which radially projects out of said tubular member transverse to said longitudinal direction,
said drip catching lip angularly extends between two ends along a circumferential portion of the pouring orifice, preferably from 120° to 180°, and has a middle portion between said two ends.

11. The aerator as claimed in claim 1, wherein:
said tubular member comprises an air recovery hole formed at said second end portion,
said air recovery conduit is in fluid communication with said air recovery hole and extends in said longitudinal direction away from said tubular member between said air recovery hole and an air inlet portion, said air inlet portion, defining an air inlet hole which is designed to introduce air into the container as the contents of the container are being poured.

12. The aerator as claimed in claim 1, wherein:
said tubular member and said aeration member are made in one piece.

13. A container-aerator assembly, comprising:
a liquid container comprising a neck extending in a longitudinal direction and terminating with a mouth delimited by an annular edge, said neck having an inner surface,
an aerator mounted at least partially inside the neck of the liquid container, said aerator comprising:
a tubular member extending in a longitudinal direction between a first end portion and a second end portion, said first end portion defining a pouring orifice and said second end portion defining a liquid passage opening for receiving the liquid to be poured that comes from the container and is directed toward said pouring orifice, said tubular member having internally a liquid passage channel which extends between said liquid passage opening and said pouring orifice to establish fluid communication between said liquid passage opening and said pouring orifice, said tubular member comprising a narrow portion whose section is smaller than the section of said liquid passage opening,
an air recovery conduit configured for introducing air into the container as the contents of the container are being poured,
at least one aeration member disposed at said narrow portion and in fluid communication with said liquid passage channel for aerating the liquid flowing from the liquid passage opening to the pouring orifice, as it is being poured, said at least one aeration member comprising at least one aeration hole formed in said tubular member at said narrow portion,
each aeration member comprises an aeration conduit in fluid communication with a respective aeration hole and projecting out of said respective aeration hole outside said tubular member in an aeration direction transverse to said longitudinal direction, wherein:
said tubular member has an outer surface which faces the inner surface of the neck along at least a longitudinal section, and is spaced from said inner surface of the neck to thereby define a gap for fluid communication between said at least one aeration member and the exterior of the container.

14. The container-aerator assembly as claimed in claim 13, wherein:
each aeration conduit projects out of the outer surface of the tubular member into the gap to withdraw air from said gap and introduce it into the liquid passage channel at said narrow portion.
